(19) United States
(12) Patent Application Publication
(10) Pub. No.: US 2004/0083489 A1
(43) Pub. Date: Apr. 29, 2004

(54) Program guide system

(76) Inventors: Atul Bansal, Coconut Creek, FL (US); Evan C. Thomas, Coral Springs, FL (US); Jason R. Jensen, Ft. Lauderdale, FL (US); Jose Soto, Ft. Lauderdale, FL (US)

Correspondence Address: HUGHES ELECTRONICS CORPORATION, PATENT DOCKET ADMINISTRATION RE/R11/A109, P O BOX 956, EL SEGUNDO, CA, 90245-0956, US

(21) Appl. No.: 10/463,001

(22) Filed: Jun. 17, 2003

Related U.S. Application Data
(60) Provisional application No. 60/421,261, filed on Oct. 25, 2002.

(51) Int. Cl. G06F 3/00; H04N 5/445; G06F 13/00

(52) U.S. Cl. 725/44; 725/54

(57) ABSTRACT

A system (10) for generating and modifying multiple unique program guides for one or more markets with respect to program content distributed in the markets via a telecommunications distribution network in accordance with a program schedule. The system includes a scheduling engine (24) for providing a first program guide for a first market and a second program guide for a second market. A user interface (22) is provided for inputting data with respect to updates for the first or the second program guide. A guide factory (28) then automatically updates or modifies the first program guides the second program guide, parameters of the system, and/or a configuration of the system in response to the user provided input data. In the illustrative application, the inventive system is used in connection with a direct broadcast satellite telecommunications network. In accordance with the invention the first and/or the second program guides may be easily split without recoding or reprogramming. A web server (33) is included to facilitate changes from a variety of remote locations.

### CROSS-REFERENCE TO RELATED APPLICATIONS

This application claims benefit of U.S. Provisional Patent Application entitled INTERNATIONAL PROGRAM GUIDE SYSTEM, filed Oct. 25, 2002, serial No. 60/421,265.

### BACKGROUND OF THE INVENTION

1. Field of the Invention

The present invention relates to communications systems and methods. More specifically, the present invention relates to systems and methods for providing a program guide for a broadcast communications network.

2. Description of the Related Art

In certain broadcast communications networks such as the Direct to Home (DTH) direct broadcast satellite network owned and operated by DIRECTV. DIRECTV delivers access to hundreds of channels of popular TV networks, movies, sports and entertainment directly to satellite mini-dishes installed in homes and businesses throughout the continental United States and abroad. DIRECTV employs broadcast centers that transmit digitally compressed programming directly to five satellites. Positioned 22,300 miles from earth, the five satellites beam programming and information directly to the miniature satellite dishes. The satellite signals are received by a receiving unit and displayed to the viewer.

In such systems, the viewer is presented with many program offerings on multiple channels. To assist the viewer in the choice of programming, a program guide is used. The program guide is a comprehensive listing of program offerings and includes a description of the program, the channel on which it is offered and the time at which the program airs. Many additional functions may be implemented via the program guide including detailed program descriptions, parental control and pay-per-view functionality to name a few.

Program guides need to be interactive and functional with minimal memory requirements. For certain international markets, the program guide must offer program options in multiple languages. Further, an ability to create custom guides to offer different program choices within different markets and receivers is highly desirable.

While conventional program guides offered multi-lingual support and a multiple guide capability, conventional program guides have been found to be limited with respect to the number of multiple guides that may be offered for current and future market opportunities. Provision of split guides in conventional program guide generation systems requires that the program guide software be rewritten or recoded. New guides could not be easily generated ‘on the fly’.

In addition, conventional program guides were limited with respect to the number of channels that could be accommodated inasmuch as the channel guide information was stored in the memory structure of the system, not in a database per se.

Accordingly, a need exists in the art for a system and method for generating program guides for satellite and other broadcast systems that is compact, offers multilingual multiple guides without additional development and is not limited with respect to the number of channels that may be accommodated.

### SUMMARY OF THE INVENTION

The need in the art is addressed by the system and method of the present invention. The invention provides a system for generating and modifying multiple unique program guides for one or more markets with respect to program content distributed in the markets via a telecommunications distribution network in accordance with a program schedule. The system includes a scheduling engine for providing a first program guide for a first market and a second program guide for a second market. A user interface is provided for inputting data with respect to updates for the first or the second program guide. A guide factory then automatically updates or modifies the first program guide, the second program guide, parameters of the system, and/or a configuration of the system in response to the user provided input data. An uplink driver cyclically transmits the program guides to an uplink system that delivers the guide to receivers.

In the illustrative application, the inventive system is used in connection with a direct broadcast satellite telecommunications network. In accordance with the invention the first and/or the second program guides may be easily split without recoding or reprogramming. A web server is included to facilitate changes from a variety of remote locations.

### BRIEF DESCRIPTION OF THE DRAWINGS

FIG. 1 is a block diagram showing an illustrative implementation of a network architecture of a system for providing program guides in accordance with the teachings of the present invention.

FIG. 2 is a block diagram showing an illustrative embodiment of the software components of a system for providing program guides in accordance with the teachings of the present invention.

FIG. 3 is a diagram showing an illustrative implementation of a software architecture for the system for providing program guides in accordance with the teachings of the present invention.

FIG. 4 is a flow diagram illustrative of a method for implementing configuration changes in the guide factory of the illustrative implementation of the teachings of the present invention.

FIG. 5 is a flow diagram illustrative of a method for implementing guide data content changes in accordance with the teachings of the present invention.

FIG. 6 is a flow diagram illustrating in more detail the replication of event and channel data objects to other IPGS servers as illustrated generally in FIG. 5.

FIG. 7 is a simplified block diagram illustrating communication between a number of guide factories.

FIG. 8 is a diagram showing the organization of guide routing information in accordance with the teachings of the present invention.

FIG. 9 is a diagram illustrating the structure of schedule data in accordance with the teachings the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

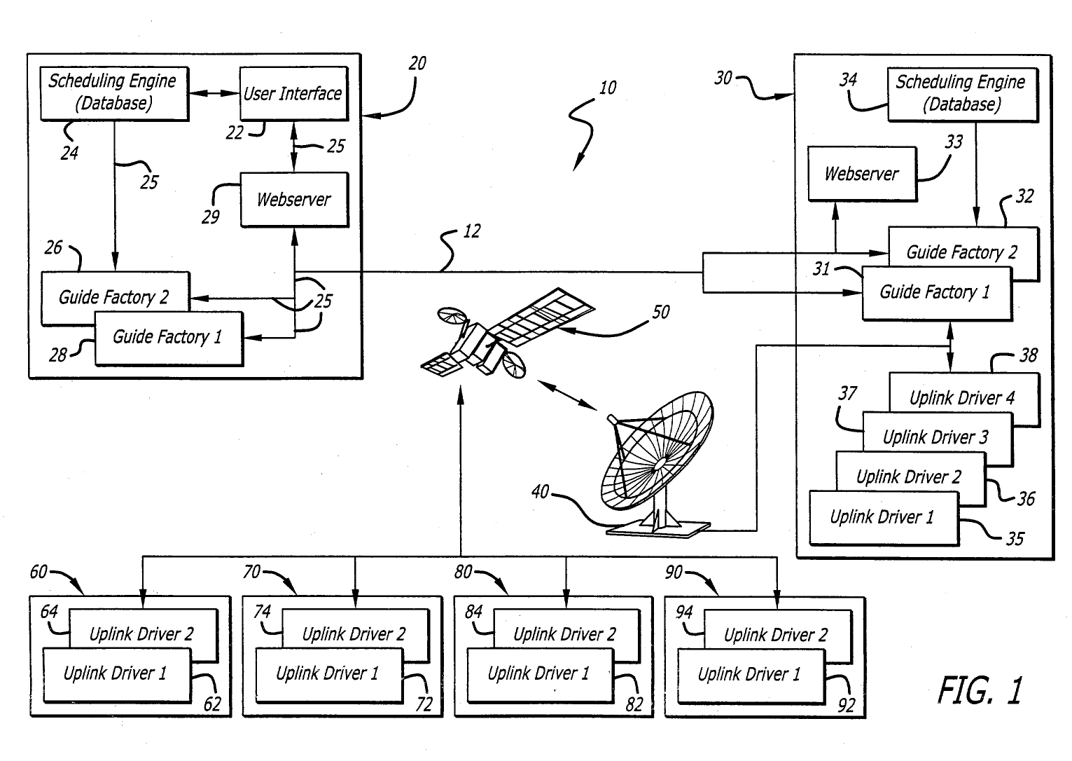

FIG. 1 is a block diagram showing an illustrative implementation of a network architecture of a system for providing program guides in accordance with the teachings of the present invention. In an illustrative application, the network 10 is adapted for use in an international program guide system (IPGS). In FIG. 1, first and second broadcast centers are shown 20 and 30, respectively. In accordance with the invention, the first broadcast center 20 includes a user interface 22 which is coupled to a scheduling engine 24. The scheduling engine 24 provides channel and event information to the IPGS Servers 26 and 28. The IPGS Servers generate chunks of program guide information as discussed more fully below. The IPGS Servers are accessed by the user interface 22 via a web server 29. The scheduling engine 24, IPGS Servers 26 and 28 and the web server 29 may be implemented with a single computer (or server) or with multiple computer systems as will be appreciated by those skilled in the art. If multiple systems are used, as illustrated in FIG. 1, the systems within the broadcast center 20 may be connected via a local area network 25.

For redundancy, the first broadcast center 20 may be connected to additional broadcast centers 30, 60, 70, 80, and 90 via suitable links such as a T1 connection 12 or a TCN connection 40. At least one of the broadcast centers (in FIG. 1, the second broadcast center 30) includes a number of uplink drivers 35-38. Each site 60, 70, 80 and 90 is equipped with redundant uplink drivers 62/64, 72/74, 82/84, and 92/94 respectively. As discussed more fully below, the uplink drivers combine program guide chunks from the guide factories into streams and communicate the streams to a satellite antenna 40. The antenna 40 uplinks the streams to one or more satellites 50 (of which only one is shown in FIG. 1). The satellites communicate program content and guide information to integrated receiver decoders (IRD) and satellite receivers in various locations.

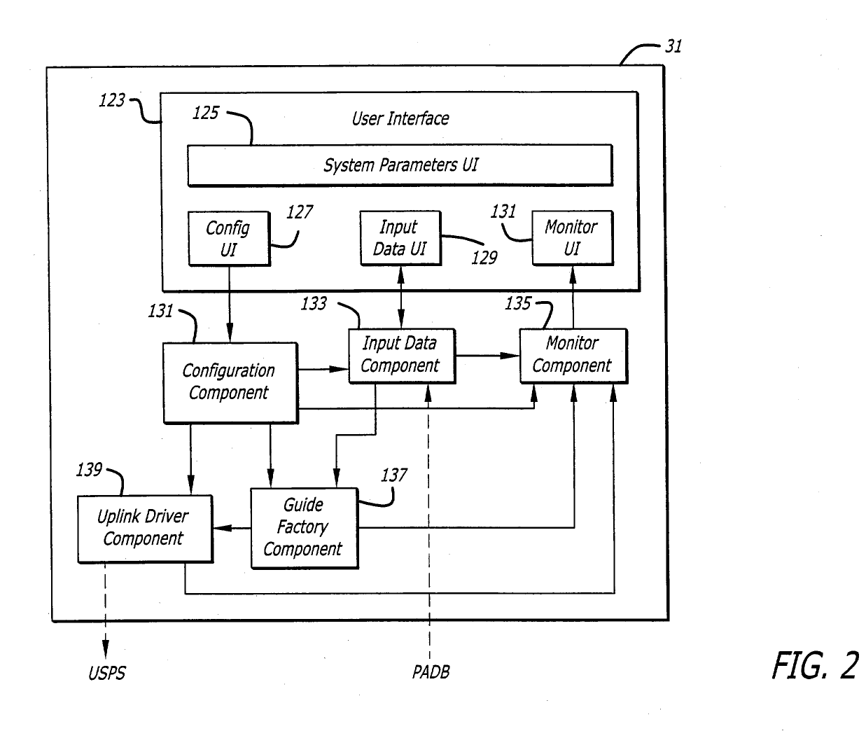

FIG. 2 is a block diagram showing an illustrative embodiment of the software components of a system for providing program guides in accordance with the teachings of the present invention. As shown in FIG. 2, the system includes a user interface 123. The user interface 123 includes a system parameters user interface 125, a configuration user interface 127, and input data user interface 129 and a monitor user interface 131. The systems parameters interface 125 provides configuration parameters with respect to the entire system 10 of FIG. 1. The configuration user interface 127, input data user interface 129 and monitor user interface 131 communicate user information to and from a configuration component 131, an input data component 133 and a monitor component 135 respectively. The input data component 133 receives information from a scheduling engine 24 or 34 of FIG. 1 as well as from the input data user interface 129. Health status is sent to the monitoring component by the configuration component 131, input data component 133, guide factory component 137 and uplink driver component 139. The configuration component 131 provides configuration data to the input data component 133, the guide factory component 137, and the uplink driver component 139. The uplink driver component outputs information to an uplink signal processing system (USPS) not shown. The USPS multiplexes the audio and video feeds of the various streams into a single stream, which is sent to the antenna 40 and uplinked to the satellite 50 (see FIG. 1) in a conventional manner. In the best mode, the satellite operates in accordance with the DTP (DIRECTV Transport Protocol). The satellite 50 relays the signals to the end-user in accordance with their account settings via an integrated receiver decoder (IRD) not shown.

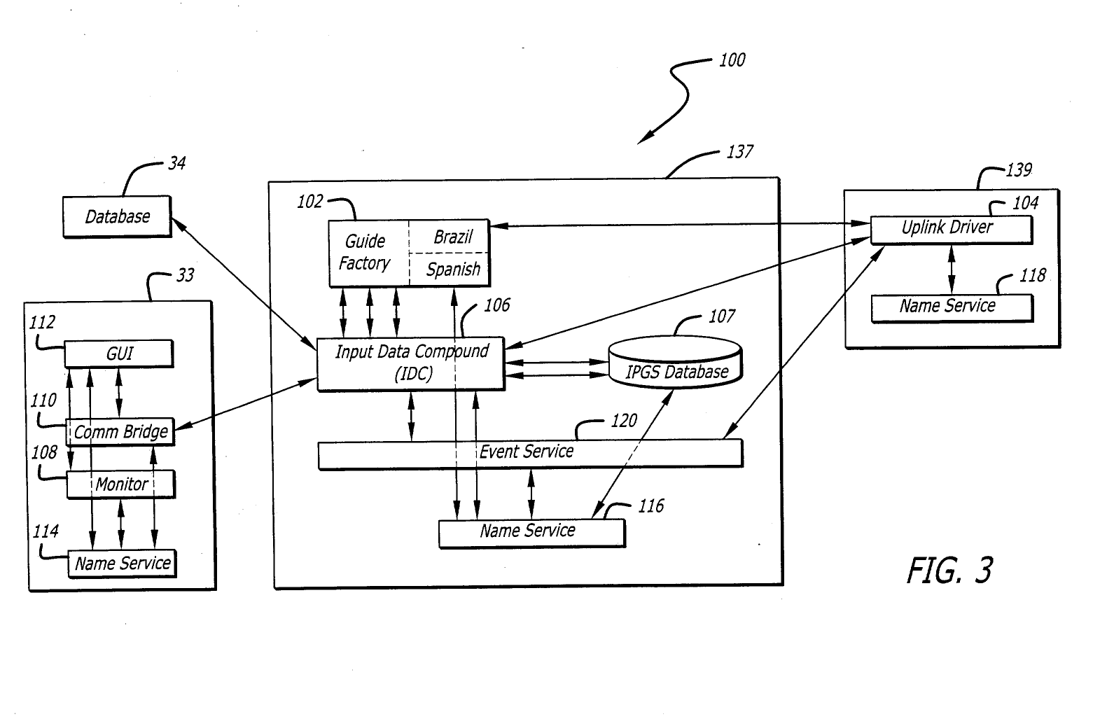

FIG. 3 is a diagram showing an illustrative implementation of a software architecture 100 for the system for providing program guides in accordance with the teachings of the present invention. The software is designed to run on the machines depicted in the network architecture 10 of FIG. 1. As illustrated in FIG. 3, several different components combine to enable the network 10 to function in accordance with the teachings of the present invention. In the illustrative embodiment, these components include a Guide Factory 102, an Uplink Driver 104, a Database 107, an Input Data Component (IDC) 106, a Monitoring Component 108, a Communication Bridge 110, a Graphical User Interface (GUI) 112, a Name Service 114, 116 and 118, an Event Service 120, a web server 33 and web browsers (not shown). In FIG. 3, configuration dataflow is shown in blue, channels and programs dataflow is shown in red, and component health status information flow is shown in yellow.

As discussed more fully below, the Guide Factory (GF) software 102 generates guide chunks and distributes them to the uplink drivers. The Uplink Driver (UD) 104 combines active guide chunks into formatted streams and cyclically transmits these streams to the configured USPS (not shown). The Database (DB) 107 maintains a persistent store of the system configuration and the scheduling information used to build guide chunks. The Input Data Component (IDC) 106 receives new configuration and scheduling data from external sources, verifies it, and disseminates the information to the rest of the system. The Monitoring Component (MC) 108 keeps track of the health of the other system components and conveys this information to any interested listeners. The Communication Bridge (CB) 110 connects the graphical user interface (GUI) 112 to the rest of the system. The User Interface (UI) 22 (FIG. 1) conveys status information to the users and allows users to configure the system. The Name Services (NS) 114, 116 and 118 maintain a persistent copy of the component instances that exist in the IPGS and enable other IPGS components to find them. The Event Service (ES) 120 forwards untargeted messages to interested listeners. The Web Server (WS) 33 makes the GUI available to anyone that wishes to run the interface. Web Browser (WB) (not shown) displays the user interface.

Several of the components reside in the IPGS Server 137: the input data component 106, an IPGS database 107, the event service 120, and the guide factory component 102. Each of these components has different responsibilities.

Input Data Component

The input data component 106 receives input from external systems, including the user interfaces. It is responsible for authenticating the origin of the input and validating the content. Once the input has been approved, the input component stores the information in the local database, notifies interested components, and issues an event describing the information. A response is usually sent to the originator of the information indicating whether the information was accepted and why. During normal operation, only one input component should receive data.

Database

The IPGS database 107 maintains persistent copies of configuration and scheduling information. This information is used to fill the guide factory's cache of data when the guide factory is first started. It is also used to hold information that is not currently needed for guide creation. This may include programs that are not currently scheduled or events that take place far in the future. The guide factory is responsible for finding these items when they become relevant. The database is responsible for replicating the data entered by the input component to all other databases on IPGS servers. Error and status events issued by other local IPGS components are stored in the database but not replicated.

Event Service

The event service 120 consists of several channels through which events may be routed. Through the event service, each component of IPGS may issue events that are delivered to all other components that have indicated an interest in those events. The event service component is a convenient method of introducing scalability and flexibility into the design. Numbers and locations of machines may be altered without modifying code or even reconfiguring existing machines to talk to them. Additional clients may also be added to perform new functionality based upon these events without affecting the existing components.

Guide Factory

The guide factory component 102 takes the configuration and scheduling information and produces guide chunks that are distributed to the uplink drivers for broadcasting. In accordance with the present teachings, the guide factory is programmed to fulfill the following responsibilities:

Process events for new configuration and scheduling information

Maintain local cache of information relevant for generation of guide for particular environments

Generate guide chunks for particular guide environments

Distribute guide chunks to uplink drivers when primary for a particular environment

Issue heartbeat events to show that the guide factory is still operating well

Issue initialization and finalization events

Monitor heartbeat, initialization and finalization events of other guide factories to configure redundancy hierarchy

Issue status/warning/error events during guide generation and distribution

While the IPGS components may be allocated to machines in many different ways, the suggested configuration for production use is to have the components assigned to three types of machines. Table 1 lists the three machines and the components that run on them in accordance with an illustrative embodiment.

TABLE 1
IPGS Machines and Components

| IPGS Server | Uplink Driver | IPGS Workstation |
|---|---|---|
| Name Service | Name Service | Name Service |
| Event Service | Uplink Driver | Monitoring Component |
| Database | | Communication Bridge |
| Input Data Component | | User Interface |
| Guide Factory | | Web Server |

The IPGS machines may be deployed at several different sites. For example, two IPGS servers and an IPGS workstation may be located in one broadcast center. Two more IPGS servers and another IPGS workstation may be provided in a another broadcast center for the purpose of increasing system reliability.

Broadcast centers have at least two uplink driver machines. More drivers may be required in broadcast centers supporting a large number of transponders. The web browsers will generally be running on all IPGS workstations, although one may be run on any machine with a connection to an IPGS Workstation.

For alternate machine configurations, there are a few constraints on how components may be allocated. A name service must be running on each IPGS machine. Any machine with a guide factory must also have a database. The monitoring component, communication bridge, user interface, and web server must reside on the same machine.

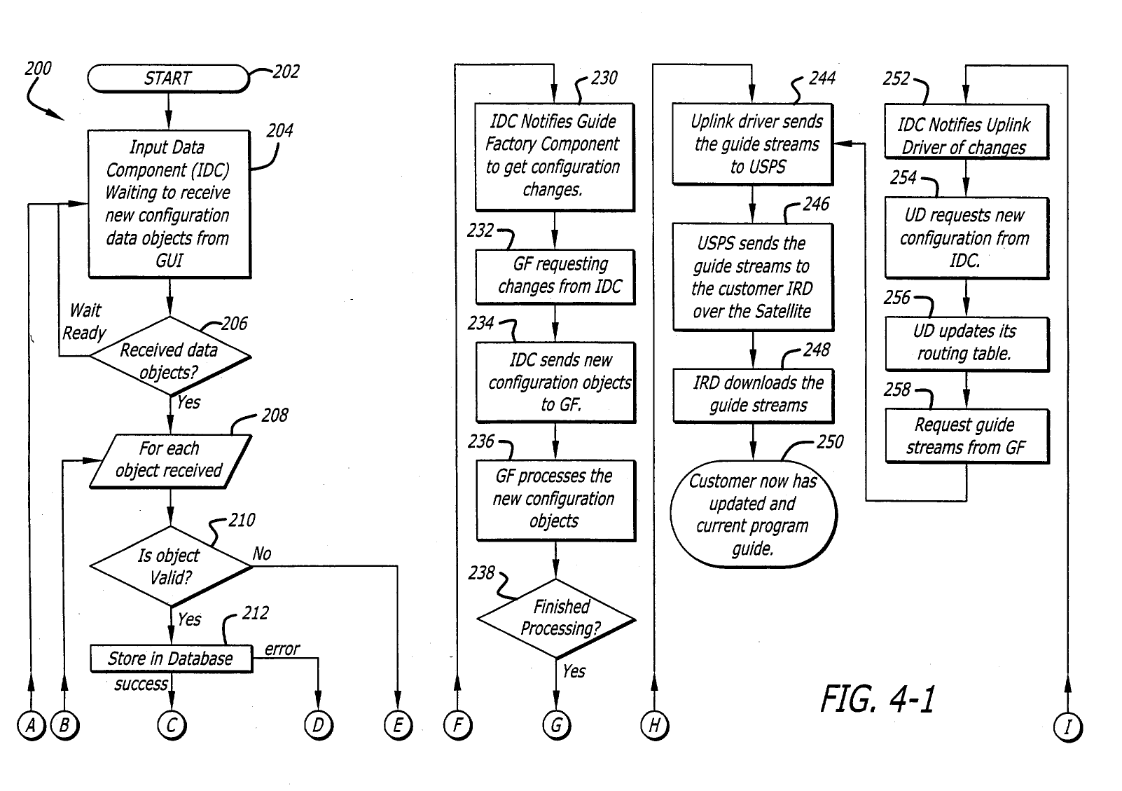

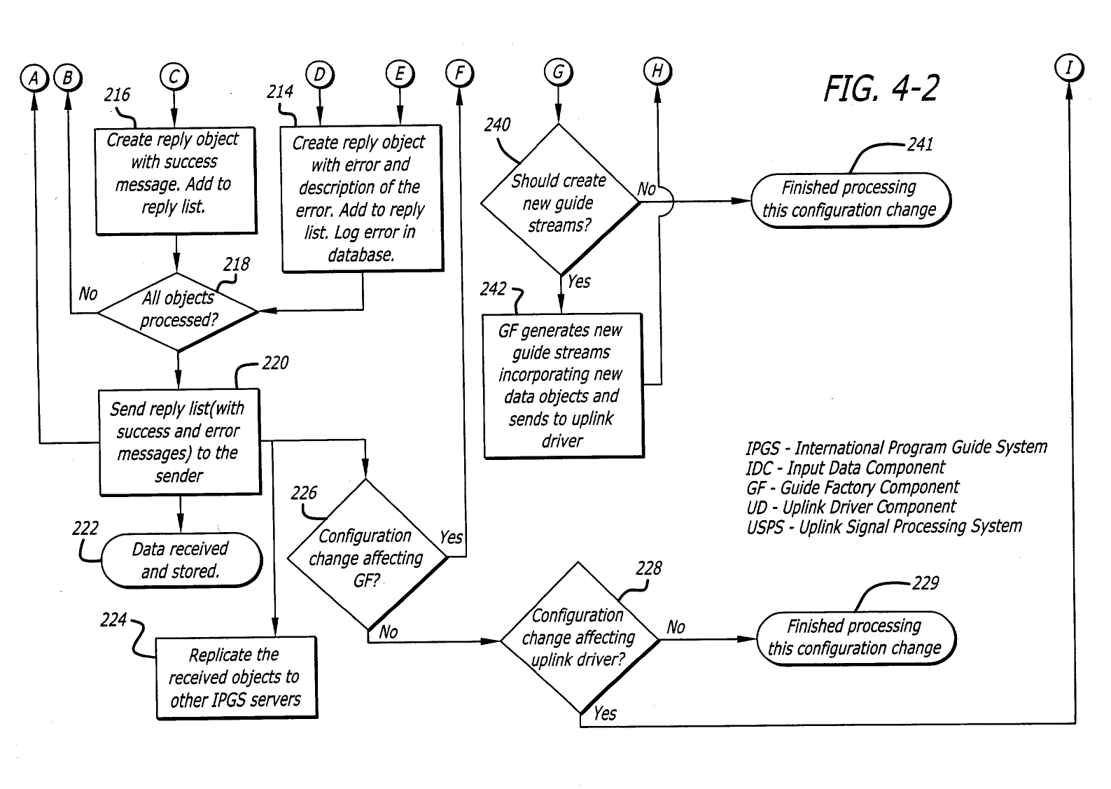

FIGS. 4-6 are flow diagrams showing an illustrative implementation of the method of the present invention. In the best mode, the method depicted in FIGS. 4-6 is implemented in software. FIG. 4 is a flow diagram illustrative of a method for implementing configuration changes in the guide factory in accordance with an illustrative implementation of the teachings of the present invention. For this purpose, ‘configuration changes’ includes Guide Environments, USPS parameters, Uplink Driver parameters, Guide Routing Tables, and overall IPGS system parameters. In FIG. 4, from the start 202, at step 204, the input data component 106 (FIG. 3) waits to receive new configuration data objects from the graphical user interface 112. On receipt of data objects from the graphical user interface 112, the input data component 106 validates each object at steps 206-210 and at step 212 stores the objects in the database 107. If the object is invalid or there is an error storing the object in the database, at step 214, a reply object is created with a description of the error, the error is added to the reply list and logged in the database. On successful storage of an object, at step 216, a reply object is created and added to the reply list. If, at step 218, all objects are processed, then at step 220 a reply list is sent to the sender with success and error messages. Thus, at step 222, configuration change data has been received and stored in the database. At step 224, the received objects are replicated to the other guide factories. If, at step 226, the configuration change data object relates to the local guide factory, the input data component notifies the guide factory component 102 to get configuration changes at step 230. At step 232 the guide factory requests changes from input data component and at step 234 the input data component sends the new configuration objects to the guide factory. At step 236 the guide factory processes the new configuration objects and, at steps 238 and 240, determines whether new guide streams need to be created by examining the configuration changes. If the new configuration defines new guide streams or alters the contents of existing guide streams, at step 242, the guide factory generates chunks for these guide streams incorporating the new data objects and sends the chunks to one or more uplink drivers. The guide factory uses the routing information (discussed later) to determine to which uplink drivers the chunks should be sent. At step 244, the uplink driver sends the guide streams to the uplink system(not shown). At step 246, the uplink system sends the guide streams to the customer integrated receiver decoder (set-top box) via the satellite 50 of FIG. 1. At step 248 the customer set-top box downloads the guide streams and therefore, at step 250, the customer has an updated and current program guide. If, at step 240, it is determined that no new guide streams need to be created, the component is finished processing the configuration change at step 241.

If at steps 226 and 228 the configuration change is determined to affect the uplink driver, at step 252 the input data component notifies the uplink driver of the changes. At step 254 the uplink driver requests new configuration data from the input data component and at step 256 updates its routing table. At step 258 the uplink driver requests guide chunks from the guide factory and at step 244 the uplink driver sends the guide streams to the customer via the uplink system (not shown). If at step 228 the configuration change is determined not to affect the uplink driver, then at step 229 the component is finished processing the configuration change.

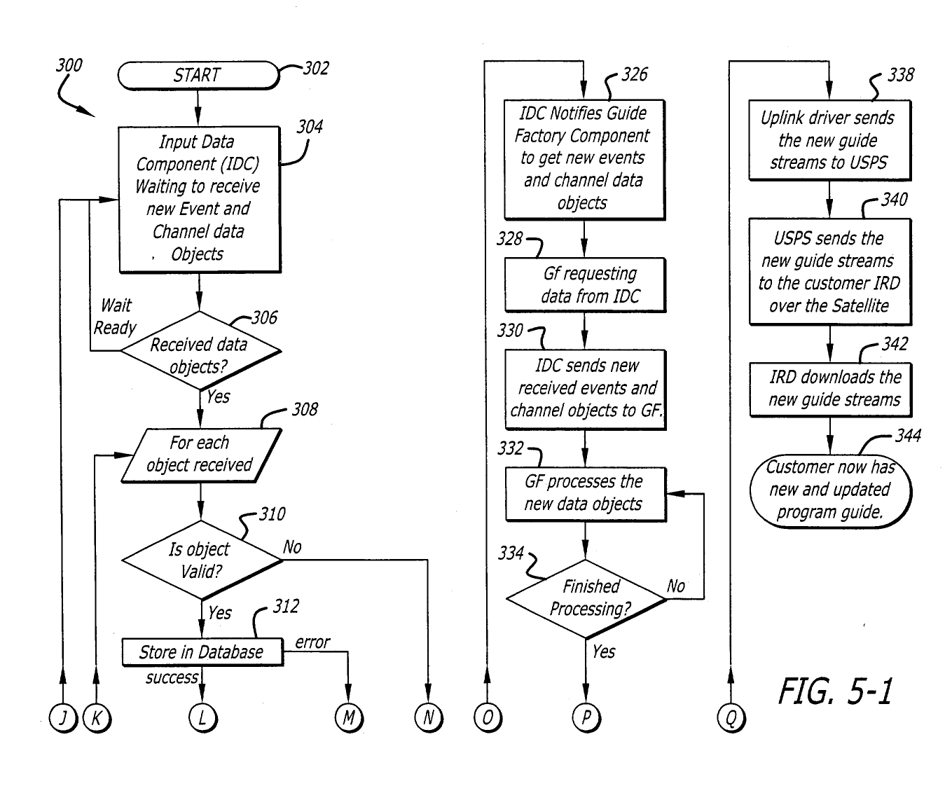

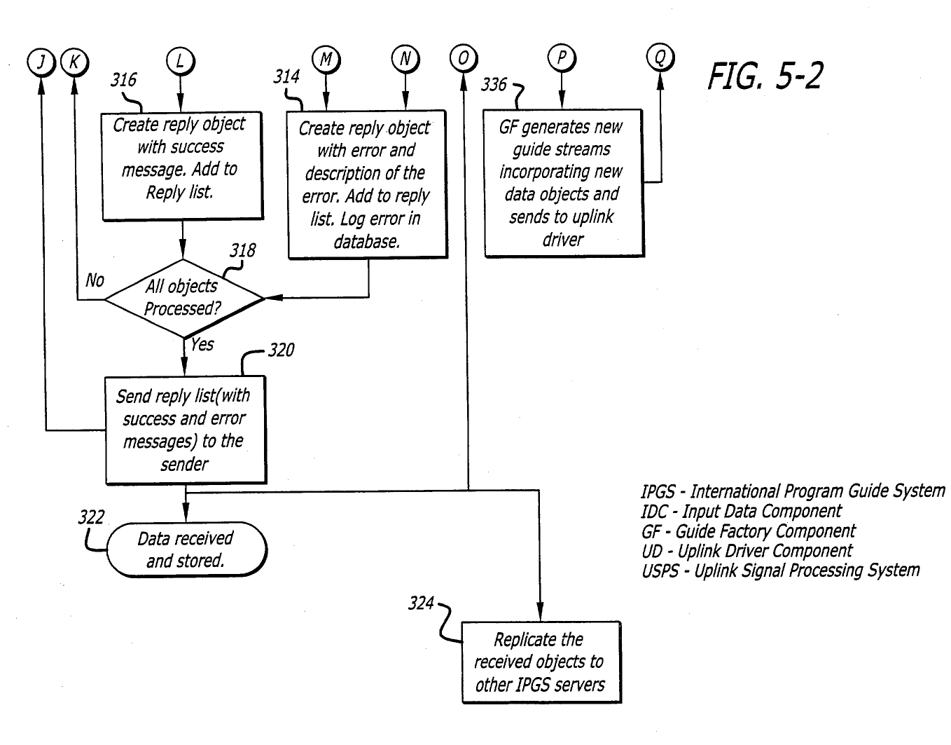

FIG. 5 is a flow diagram illustrative of a method for implementing guide data content changes in accordance with the teachings of the present invention. The diagram of FIG. 5 is similar to that of FIG. 4 with the exception that in FIG. 5 the changes are not sent to the uplink drivers. FIG. 5 shows that at step 304, the input data component 106 waits to receive new event and channel data objects. On receipt of these objects, the input data component validates the objects, stores them in the database and sends them to the guide factory for transmission to the customer in the manner disclosed in FIG. 4 above. Note that at step 324, the input data component replicates the received objects to the other guide factories.

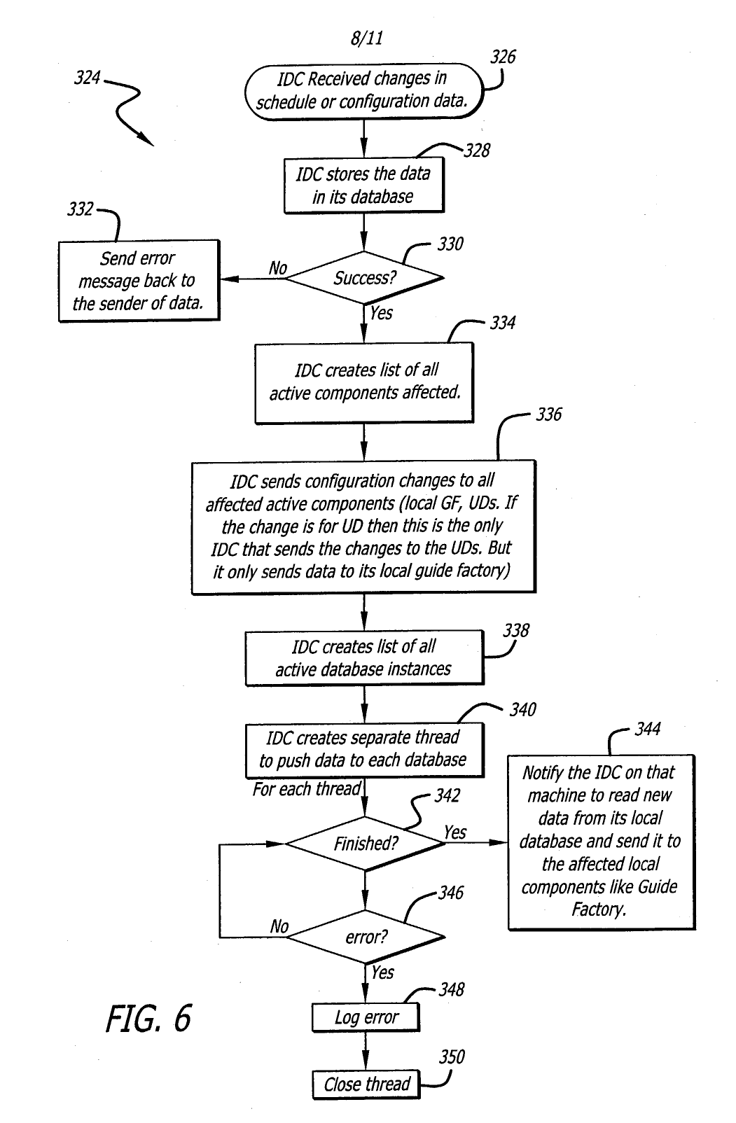

FIG. 6 is a flow diagram illustrating in more detail the replication of event and channel data objects to the other guide factories as illustrated generally in FIG. 5. The method depicted in the flow diagram of FIG. 6 allows for the data to be replicated to the other machines in the system in a manner that is transparent to the system administrator with respect to the number of servers or other machines employed. In FIG. 6, all incoming data is validated by the receiving input data component and then stored in its local database. (In this context, ‘local’ means residing on the same machine. The input data component, guide factory and database reside on the same machine so they are local to each other.) It then forces the database to synchronize. When synchronization is complete, it notifies other input data components to read their local database and then send data to the affected local components. If the affected component is not local, e.g., uplink driver, then only the receiving input data component sends the data to that component.

Thus, at step 326, on receipt of changes in schedule or configuration data, the input data component stores the data in its database as discussed above and illustrated generally at step 328. If the storage step is successful, at step 334, the input data component creates a list of all active devices that are affected by the change. At step 336, the configuration changes are sent to the uplink driver and the affected active devices. At step 338, the input data component creates a list of all active database instances and at step 340 the input data component creates a separate thread to push data to each database so identified. For each thread, at step 344, it notifies the input data component on the machine on which each active database is located to read data from its local database and send it to all affected local components such as the local guide factory.

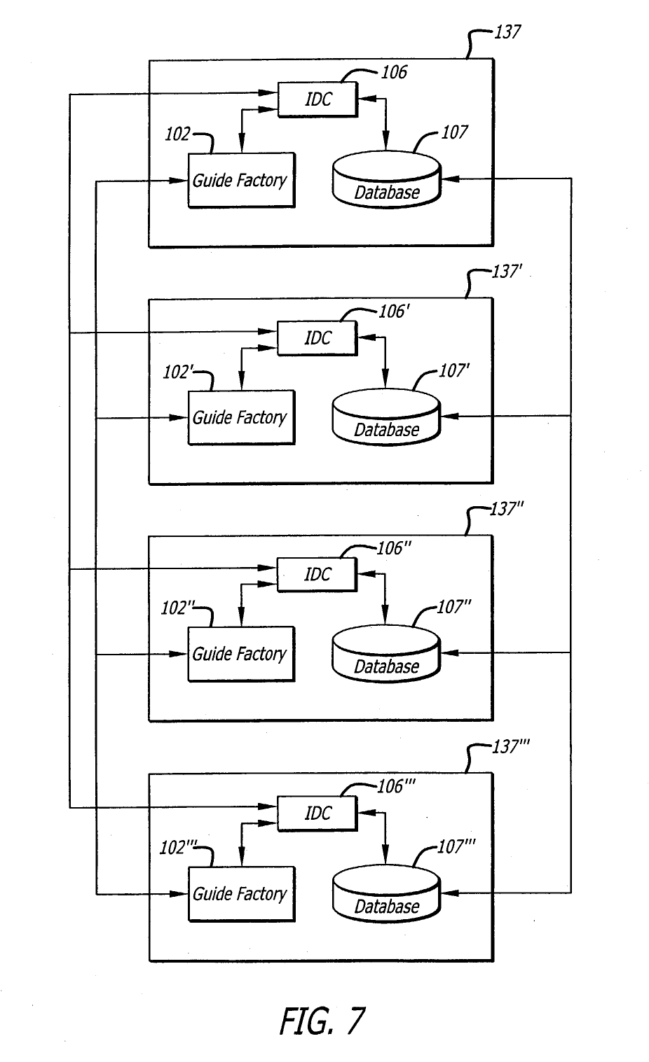

FIG. 7 is a simplified block diagram illustrating communication between a number of guide factories 137. Each input data component (IDC) 106 is the only component that talks to the associated database 107 directly. The four input data components 106, 106′, 106″, and 106′″ can talk to each other and send notifications to each other, but cannot access each other's database. In the illustrative embodiment, the databases are synchronized using asynchronous replication. The databases are set to be synchronized every few minutes by themselves. However, when an IDC receives data, it updates its copy of the database and forces the database to synchronize with the other three databases, i.e. the database starts updating the other three databases. In the event that the synchronization fails (e.g., machine down), then it saves the data that needs to be sent to the database that was down and sends it whenever that database comes up. In accordance with the present teachings, the databases are synchronized with each other without user intervention. Every component other than the IDC talks to the database through the IDC. All components request and submit data to the database through the IDC. In case of an error, the IDC returns an error to the calling component.

An IPGS may have multiple instances of each component to provide redundancy and load balancing capabilities. A component instance is hereafter called a device. Each device can be uniquely identified by its type and the host name of the machine on which it is running. Some device types are guide factory, input data component, event service, uplink driver, monitoring component, and communication bridge. Because of this method of identification, only one device of each component type may be run on a single machine. Multiple instances of an IPGS component may be run on a single machine at one time; however, each instance must be part of a completely different system of devices.

Communication between IPGS devices is achieved through CORBA. Interfaces and messages for each component are defined in CORBA IDL. Device ids are included in the message parameters to identify to originator of each message.

A new device is added to the system by registering it with the federated name service. This informs every other active IPGS machine that the new device will be available on the given machine. Each IPGS machine maintains a persistent set of the location (i.e., hostname) of each device. A device may be permanently removed from the system by unregistering it with the name service. Registration is normally performed only when a new machine is being added to the system.

Several actions are performed whenever a device is started. The device lists one or more references to itself in the name service running on the device's machine. Other devices may find these bindings (and therefore, references to the device being started) through their local name service. The device also publishes an initialization event announcing that it has been started. This allows other devices to be alerted when new devices are started, instead of forcing them to poll for new devices.

Similar actions are performed when a device is stopped. A finalization event is issued notifying other interested devices that the device is stopping. The references to the device being stopped are removed from the name service. The name service still indicates that the device resides on that machine, but it does not have more specific information about contacting the device. Devices shall not attempt to contact devices that are not running.

Not all components need to follow these guidelines. For instance, neither the web server nor the name service performs any of these actions. Nor is registration needed for these components.

To ensure the stability of the IPGS, redundant instances of the IPGS server might be deployed. Redundancy is managed differently for each of the server components.

All input components are active and capable of receiving input; however, only one input component is considered primary. All external systems (e.g., GUIs and PADB) are expected to connect to the primary input component. If a connection cannot be established with the primary input component, then a new primary input component is chosen. All external systems should follow the same algorithm for determining the new primary input component. This ensures that there is exactly one entry point for data in the IPGS, which minimizes the possibility of race conditions. No internal mechanism for promoting a backup input component to primary is necessary since it is the external system that controls which instance is contacted.

Input components and guide factories will directly communicate only with the database that resides locally on the same machine. The database is responsible for replicating configuration and scheduling data to the databases on the other IPGS servers in a timely manner. Because input may be received by any IPGS server, the replication will be symmetric. However, under normal circumstances, replicated data should only originate on the machine with the primary input component. Except for configuration, the replication is fully managed by Oracle software.

Redundancy for the event services is transparent. Any application interested in receiving events should register with all of the available event services. When issuing an event, an application only needs to send the event to one event service. This requires that event consumers be alerted via an event when a new event service becomes available. Local event channels will also be available to support events that are of no interest to components external to the IPGS server machine on which the event channel resides.

The redundancy of guide factories is fully configurable from the user interface. For each guide environment, only one guide factory is considered primary. This guide factory is responsible for delivering the guide chunks for that environment to each uplink driver that needs them. Other guide factories may also support that guide environment by generating its guide chunks. However, these secondary guide factories will not transmit any guide chunks to drivers unless the primary factory fails to do so.

Because secondary guide factories must automatically take over when a primary fails, the IPGS must have a method of detecting this. For this purpose, each guide factory will periodically issue a heartbeat event describing its status. By monitoring these events, secondary guide factories can determine when a primary guide factory has failed. For instance, if no heartbeats are received from the primary guide factory for a predetermined interval, secondary guide factories can assume that the primary guide factory has crashed. Alternatively, a heartbeat may indicate that the primary guide factory has entered a state from which it cannot generate or deliver guide chunks for the guide environment in question.

Each guide factory performs a variety of tasks including:

Periodically emitting a health event describing the status and activity of the factory

Listening for health events of all guide factories

Listening for configuration information from input data components

Listening for notices of new scheduling information from input data components

Listening for guide data requests from drivers

Listening for initialization and finalization events from other devices

Supporting a number of configured guide environments

A guide factory supports a guide environment in one of three modes: inactive, active, or primary. Because a guide factory may support several environments at once, it can operate in more than one mode at any time.

When inactively supporting a guide environment, a guide factory maintains configuration information for the environment, but does not perform any work for that environment such as processing schedule items or generating guides.

Active support of a guide environment by a guide factory increases the responsibilities of the guide factory. The guide factory must now:

maintain configuration information for the environment,

maintain a cache of the schedule items currently relevant to the guide environment,

generate guide chunks for the guide environment,

log activities performed for the guide environment,

and log problems encountered while supporting the guide environment.

Primary support of a guide environment is identical to active support with the additional responsibility of transmitting the generated guide chunks to the required uplink drivers.

Several guide factories may support a single guide environment. Any number of guide factories may support the guide environment in active or inactive modes. However, for each guide environment, exactly one guide factory shall be in primary mode at any time.

For a configured guide environment, each guide factory has a numeric priority. A user initially assigns this priority, but guide factories may lower their own priority under certain circumstances. A priority of ‘0’ means that the guide factory is inactive for that environment (negative priorities are treated as zero). A positive priority causes the guide factory to be active for that environment. The guide factory with the highest priority for a guide environment is the primary guide factory for that guide environment. A lexicographical comparison of device ids is used to break ties. The default priority for a guide environment is 1. The priority for all guide environments is reset to this when a guide factory is restarted.

The health of a guide factory includes its priority for each supported guide environment and whether it considers itself primary for each guide environment. Each guide factory monitors the health of the other guide factories so that each guide factory knows what the others are doing.

Automatic Promotion of Guide Factories

When a guide factory encounters an error servicing a single guide environment, its priority for that guide environment is lowered. This may cause the guide factory to no longer be primary for that guide environment. In severe cases, this may cause the guide factory to become inactive for that guide environment. When larger problems (e.g., failed connection to local database or name service) occur in a guide factory, the priorities for all supported guide environments may be lowered. When a guide factory is shut down, all of its priorities are set to zero. Other guide factories automatically make this adjustment upon receiving the guide factory's finalization event.

When a guide factory detects that all other guide factories have a lower priority for a given guide environment, that guide factory promotes itself to primary for that guide environment. This usually occurs when the guide factory receives a health or finalization event from the guide factory which was previously primary for that guide environment. Upon becoming primary, the guide factory transmits each of the chunks which have been generated for the guide environment to the pertinent drivers.

When a guide factory fails to receive a health event from another primary guide factory for a predetermined amount of time, it assumes the guide factory has failed, and lowers the priority for that guide factory. No further checks are made.

When a predetermined amount of time passes without receiving a health event from a guide factory, other guide factories attempt to directly request its health. If the health is successfully acquired, there is probably a problem with the event service. If this cannot be resolved, all of the priorities for the guide factory that was not issuing its health events are lowered. This may cause other guide factories to become primary.

If the guide factory in question is not directly accessible, the other guide factories attempt to contact the name service on that machine. If this can be contacted, it is assumed that the guide factory in question has aborted. The other guide factories reset their copy of the failed guide factory's priorities to ‘0’. This may promote new guide factories to primary mode for certain environments. A ping of the guide factory's machine may also be performed if the name service is unresponsive.

If no contact can be made with the machine on which the guide factory is running, there are two likely possibilities. Either the machine has been shut down, or the network connection has been severed. The guide factory that has noticed the silence of another guide factory attempts to contact another machine on the same subnet as the silent guide factory. If contact is made, it is assumed that the silent guide factory is no longer functional and its priorities are lowered to zero.

If no contact can be made with any machine on that subnet, it is assumed that a network problem exists. No automatic alteration is made to guide factory priorities, but an error condition is sent to the user interface (which, of course, may not be accessible). If a guide factory request is received in this state, a guide factory may become primary for that guide environment if it is next in line among the responsive guide factories.

Because each guide factory holds a local copy of the priorities for every other guide factory, the potential for inconsistencies exists. When a guide factory is not running, its true priorities are all zero. When the guide factory is running, its true priorities are the priorities that are stored locally within that guide factory. These priorities are contained within the health events that are sent to the other guide factories. Guide factories shall accept the priorities received in these events as accurate, and any local alterations to the priorities for that guide factory shall be discarded when a health event is received. This may cause the receiving guide factory to switch from primary to active for certain guide environments.

If guide factory A determines that guide factory B is primary for a guide environment when it should not be, A may send its knowledge of the state of the guide factories in the IPGS directly to B. This shall cause B to correct its mode. Similar action may also be taken when a guide factory that should be primary for a guide environment does not consider itself to be primary. In some cases guide factory B may have more accurate information about the state of the other guide factories. In this case, B may reply to A with its knowledge of the state of the guide factories in the IPGS.

The user interface indicates whenever an automatic promotion or demotion occurs. When the primary guide factory for an environment cannot properly be determined automatically, a major alarm shall be emitted.

Once the IPGS has detected that a primary guide factory for a guide environment has failed, only one secondary guide factory must be promoted. In addition to selecting the primary guide factory, privileged users may select the order in which secondary guide factories will be promoted by assigning each factory a different priority for that guide environment. This order can be different for each guide environment. Once the failure of a primary guide factory is detected, the secondary guide factories will probe the other guide factories (including the primary) to determine which healthy guide factory has the highest priority. This factory becomes the primary guide factory for the guide environment in question and the priority of the previous primary guide factory is lowered. Privileged users may always affect which guide factories are primary by modifying the guide factory priorities or by halting an IPGS server containing a primary guide factory.

Event Service

The event service is used to route messages from one device to a number of other devices that have indicated an interest in that type of message. Several instances of the event service may exist in the IPGS. Each event service has several different channels. An interface is defined (in IDL) for each channel. This interface specifies a set of events that can be issued on that channel. A reference for each channel is listed in the local name service. Several different types of messages may be sent through one channel, but they must all belong to the same interface.

A device that wants to emit an event may send a message to any of the existing channels for that interface. Devices listening for events must connect to all of the existing channels for that interface. This requires that all listening devices be notified when event channels are started, so that they may connect to the new channels.

When an event service is started, it creates an event channel for each event interface and lists a reference to each channel in the local name service. An event is then sent through the DeviceCollector channel of an event service that was already running. This informs all listening devices that a new event service has been started and that they must connect to the new channels. When an event service is shut down cleanly, it automatically sends a disconnection message to all connected devices. This permits the listeners (and suppliers) to clean up their resources.

Because other components require the event service to learn when new devices are added to the system, an event service shall be one of the first devices started in an IPGS (after its local name service). For maximum reliability, listeners may periodically search the name service for event services with which they are not connected.

Table 2 lists the event channels used by the drivers and guide factories in the illustrative embodiment of the invention. Additional channels may be needed by other components or for conveying error messages to remote processes.

TABLE 2
Event Types

| | | Name Service | | |
|---|---|---|---|---|
| Channel Name | Interface Type | Binding | Suppliers | Consumers |
| ChunkServer | ChunkServer | ChunkServer | UD | GF |
| DeviceCollector | DeviceCollector | DeviceCollector | UD, GF, | GF, Monitoring |
| | | | ES | component, |
| | | | | IDC |
| DriverMonitor | DriverMonitor | DriverMonitor | UD | Monitoring |
| | | | | component |
| GuideFactoryMonitor | GuideFactoryMonitor | GuideFactoryMonitor | GF | GF, Monitoring |
| | | | | component |

ChunkServer

This interface permits a driver to request guide data that it expects to have, but has not received. Its only operation is

requestChunk(in DeviceId origin,

in Driver callback,

in GuideStreamId stream,

in Date time,

in long count)

Drivers issue this event when they detect a time for which they do not have a valid guide chunk. Guide factories listen to this message and the primary guide factory responds by sending a newGuideData message to the Driver reference, callback, containing guide chunks that are active for the given time on the specified guide stream.

If the driver receives no response, it periodically resends the event. Each time the event is sent, the count is incremented. As the count gets higher, secondary guide factories begin to respond to the event in a deterministic manner.

DeviceCollector

This interface permits a server to keep track of which components of the system are running and which are not. The operations in the DeviceCollector interface are

deviceStarted(in DeviceId device,

in Object admin,

in long count)

and

deviceStopped(in DeviceId)

When an IPGS device is started, it issues a deviceStarted event to inform the rest of the system that it has been started. When the component expects a response to this event (e.g., to supply initial configuration information), the device may periodically resend the event with an incremented count until the response is received. This permits secondary machines to respond to the event when the primary fails to do so. The admin reference provides a callback object for the primary reference of the component being started. Generally, this is a DeviceAdmin object, but when the device is an event service it is a TypedEventChannelFactory.

The complementary event, deviceStopped, is issued when the component cleanly shuts down. This informs the rest of the system that messages shall no longer be sent to the component, and that failures to contact or hear from the component shall not be considered errors.

When a driver is started, it must receive its routing information, its general configuration parameters, and the guide data to be broadcast. Until the driver receives a setDriverRouting( ) message, a setParameters( ) message, a setApplicationTimeOffset( ) message, and newGuideData( ) messages for each guide stream transmitted by the driver, it periodically issues the deviceStarted event.

When a guide factory is started, it must be told which guides to generate and where to send them. A guide factory periodically issues a deviceStarted event until it receives a setParameters( ) message, at least one defineEnvironment( ) message accompanied by a setHierarchy( ) message for that environment, a setApplicationTimeOffset( ) message, and a setFactoryRouting( ) message.

When an event service is started, any components that listen for events must connect to the appropriate new channels. For this reason, a deviceStarted event is issued through a different event service indicating that the new event service is available. It is the responsibility of the listeners to find and connect to the appropriate event channels by accessing the supplied TypedEventChannelFactory.

The monitoring component may receive these events in order to show when components are brought up and down (and so that it may know if a new event service comes on-line). A guide factory must receive these events so that it may send information to drivers when they are started and so that it may recognize when a primary guide factory is cleanly shut down. The IDC may need to receive these events so that it may provide configuration information to guide factories and drivers when they are started.

DriverMonitor

The DriverMonitor interface allows the health of the driver to be monitored remotely. Each driver periodically issues a driverHealth message reporting its current health. This message includes the identity of the driver whose health is being reported, the actual time at which the health was measured and a structure describing the health. This structure consists of a number describing the general health of the driver and a sequence of numbers describing the health of each configured connection. To match the connection healths to a description of the connection, an identifier for the current routing configuration is also included.

driverHealth(in DeviceId origin,

in Date when,

in Health status)

Whenever, a driver receives a setDriverRouting( ) message that successfully modifies the driver's routing information, a newDriverRouting( ) event is issued. The driver assigns a routingId to the new configuration so that it may be matched to subsequent driverHealth( ) messages. The purpose of separating the information into two messages is to conserve bandwidth.

newDriverRouting(in DeviceId origin,

in long routingId,

in DriverRouting routes)

The monitoring component is probably the only component that is interested in receiving these events, which it uses to draw the monitoring display.

GuideFactoryMonitor

The GuideFactoryMonitor interface allows the health of the guide factory to be remotely monitored. Each guide factory periodically issues a factoryHealth message reporting its current health. The monitoring component receives these events to build the monitoring display and the guide factories receive these events to determine when promotion of a secondary guide factory is necessary.

The health of a guide factory is a structure that includes numbers describing the general status of the guide factory, the status of its connection to its local database, a list of drivers to which it has failed to connect, and status information for each configured guide environment. The information for a guide environment includes the name of the environment, a numeric status, an enumerated value indicating what the guide factory is currently doing for this environment, a flag indicating whether the guide factory is primary for this environment, and the priority of the guide factory for this environment.

factoryHealth(in DeviceId origin,

in Date when,

in GuideFactoryHealth health)

Uplink Driver

The uplink driver sends guide streams to the uplink system so that they may be transmitted to the satellite. An uplink driver can open many TCP connections to the different uplink systems. Uplink drivers are deployed in redundant pairs. At any point, if a connection fails then the other uplink driver will establish a replacement connection. So at any given point in the configured connections are shared between the two uplink drivers. Neither uplink driver is performing all of the sends, but the combination of drivers work together to transmit all the configured data.

The guide factory only sends the guide chunks once to the uplink driver after each guide generation, while the uplink driver cyclically sends those chunks to the USPS. Uplink drivers continue to send the same chunk over and over again, till the chunk is out of date.

The guide factory sends guide data directly to only one uplink driver in a broadcast center. That uplink driver is responsible for forwarding the data to the other local uplink drivers. This is done because the bandwidth of the network connections between broadcast centers is low relative to the bandwidth of the connections within a broadcast center.

One of the most important pieces of configuration information is guide stream routing. That is, where will the receivers look for each guide stream and how will the IPGS get the data there. Guide streams are routed in several small steps. First, the guide factories distribute guide chunks to uplink drivers. Then, the uplink drivers send those chunks to specific ports on uplink systems. The uplink systems combine the data from the drivers with data from other systems and send it all to a particular transponder, which broadcasts the data to a fixed geographical region. Receivers that know where to look can then access this data.

In the illustrative example, each step of the route is configured separately to provide a user-friendly method for configuring the routing information. Privileged users can specify on which transponders and SCIDs a guide stream will be broadcast. A SCID is a service channel id that distinguishes a guide stream from other data that is being broadcast on a transponder. The combined address of a transponder and a SCID is hereafter referred to as a service channel. They can also specify which uplink systems (USPS) support which transponders and SCIDs. The possible connections between uplink drivers and uplink systems are also configurable. The IPGS can then combine all of this information to successfully route guide chunks from the guide factories to the receivers. When a change in the system occurs, just that change may be entered into the IPGS and it will adapt to the new route.

The first piece of the routing information is the data that is to be routed. Each guide environment is comprised of several guide streams. For instance, guide environments for OpenTV-compatible IRDs may have an MPG stream, several SPG streams, and several DIP streams. Each of the configured streams must now be assigned one or more destinations.

The second piece of the routing information is the set of available destinations for guide streams. A collection of active transponders is maintained. Several attributes of the transponder are maintained, such as the satellite and beam to which it belongs, its physical transmission number, and its transmission characteristics (e.g., frequency, polarity, etc.). When a new transponder becomes available, a privileged user may add its description to the collection of transponders. This facilitates future satellite expansion.

Once guide streams and transponders are represented, the top-level route of each guide stream may be configured. Each guide stream is associated with one or more transponder/SCID combinations. Each association represents one place from which a receiver can access that guide stream. A data rate is also attached to the guide stream/service channel association. This allows each instance of the stream to be throttled. Note that the route that is associated with each guide stream is a transponder and SCID. This corresponds to the level at which guide placement is normally controlled.

A means of getting guide streams to the desired service channel (i.e., transponder/SCID combination) must also be described. Each service channel is associated with ports on one or more uplink systems. When the IPGS needs to send a guide stream to a particular service channel, it should transmit the stream's data to every uplink system port associated with that service channel. Associations between uplink addresses and service channels may be freely modified to reflect the configuration of uplink systems. The system will adapt to such modifications by rerouting the guide streams internally in a manner consistent with the new configuration. Generally, all of the ports for an uplink system are associated with the service channels of a single transponder, and the relationship between SCID and port number is usually constant. This reflects standard practice, where each uplink system supplies all the data for exactly one transponder. Additional flexibility is provided for future developments, however.

The last piece of the routing is internal to the IPGS. The IPGS must know which of its components can access each uplink system, so it maintains a collection of data about its uplink driver machines and which drivers should transmit to which uplink systems. As an added measure of security, a simple representation of the locality of each uplink system and uplink driver is provided. Uplink drivers can only talk to uplink systems that reside in the same site.

Once the primary guide factory creates a guide chunk, it is responsible for delivering it to all of the drivers that need the data. To find this set of drivers, the factory identifies the guide stream to which the chunk belongs. From there, it collects every route associated with that guide stream, which yields a set of service channels. Each of these service channels is supported by a set of uplink system addresses, and each of these is reachable by one or more uplink drivers. The guide factory follows this chain to produce the complete set of drivers that can service any of the guide routes. The new chunk is then distributed to every driver in this set. Determination of this set of drivers need not be done every time a chunk is distributed. The routing tables are generally constant, so the guide stream destination sets can be found when a user reconfigures one or more of the tables. Then, the guide factories need only remember the set of uplink drivers for each guide stream.

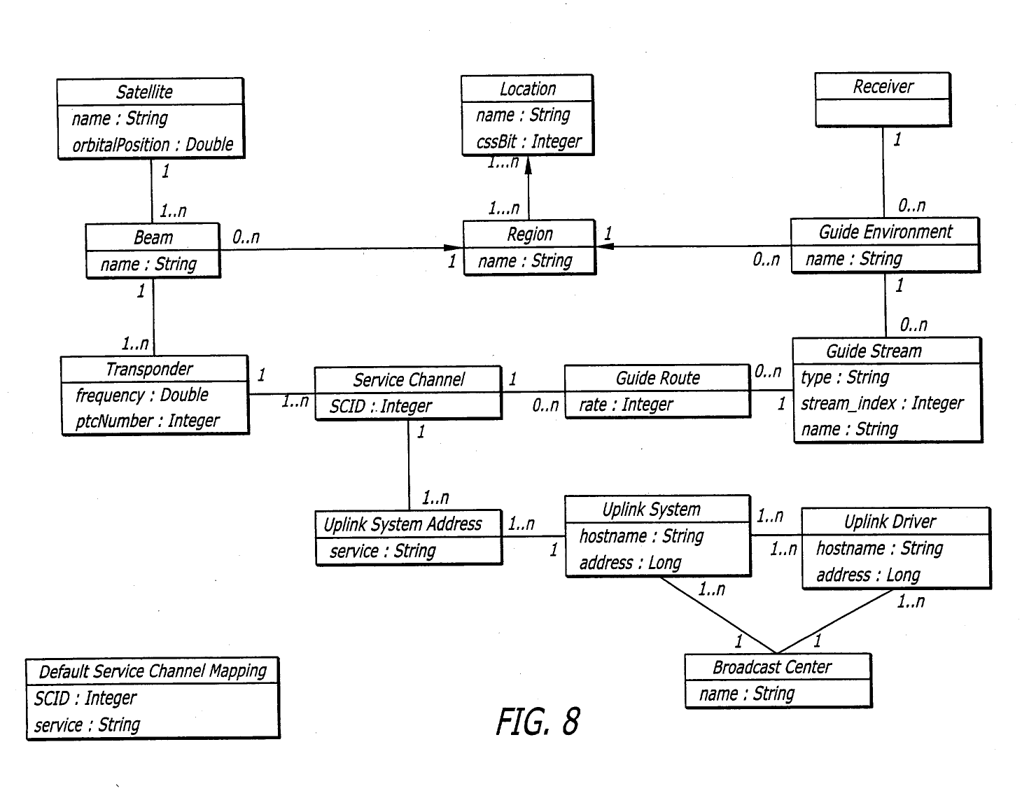

FIG. 8 is a diagram showing the organization of guide routing information in accordance with the teachings of the present invention. The uplink drivers have different requirements for routing information than the guide factory. Each uplink driver must know which guide streams it will transmit and to which uplink system addresses to send each stream and at what rate. This information can be determined from the routing information in a similar. Drivers may send a single guide stream to several different locations, so duplicates cannot be ignored here (the guide factory didn't care about duplicates). The flattened table of guide stream to uplink driver relationships can then be sorted and the relevant rows sent to each uplink driver.

Scheduling Data

To provide flexibility for future content, the scheduling data is maintained in a normalized manner. Programs and channels are still important objects in the schedule, but their relationship has been decoupled.

A program is a unit of content that is provided to the customer. There may be many different kinds of programs. Today's guide contains only conventional programs, which can be described by their title, description, category, rating, and some other attributes. Future receivers may support new types of programs, such as XML programs, which could be described with a URL.

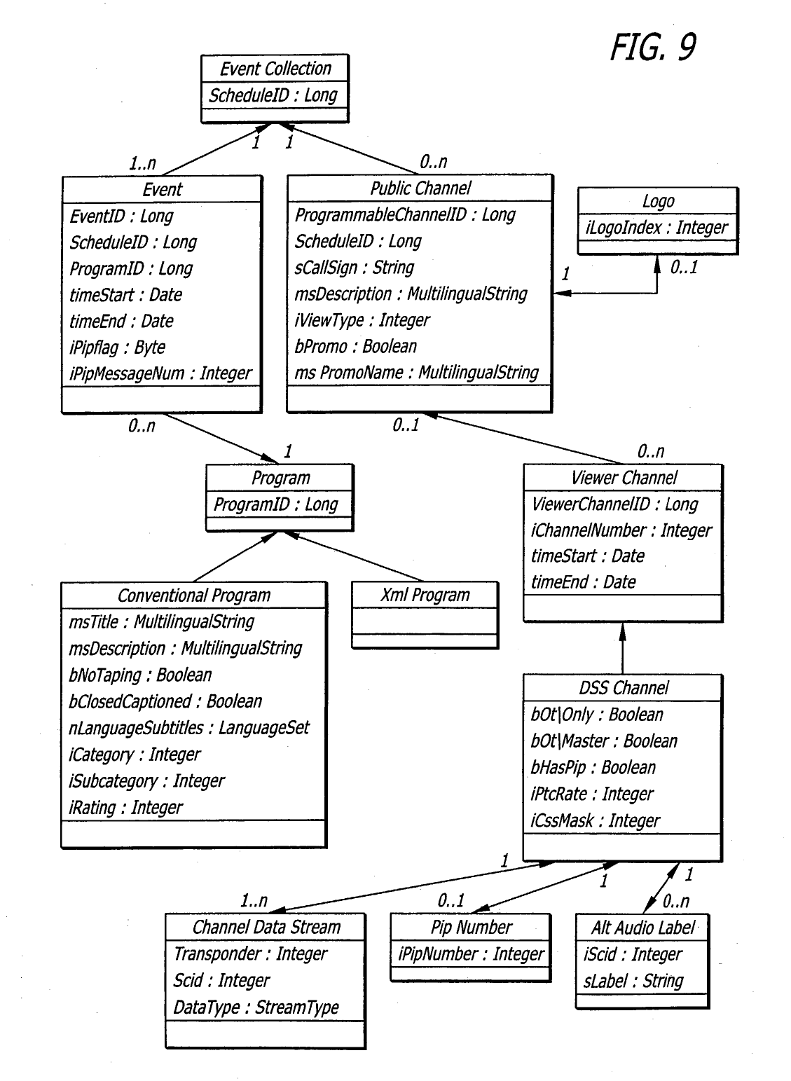

FIG. 9 is a diagram illustrating the structure of schedule data in accordance with the teachings of the present invention. The common characteristic of all types of programs is that they can be scheduled. That is, a time may be selected during which the program is available to viewers. The association of a program with a start and end time is called an event. Events do not generally occur by themselves. To represent a common grouping of events, each event belongs to a single event collection. An event collection may correspond to the programming of a television network (e.g., HBO's schedule), or it may be more artificial (e.g., special sporting events). Within a single event collection, events for conventional programs cannot overlap. Event collections are independent of how programs will be transmitted or accessed (i.e., the channel). This means that channels can be reconfigured at any time without resubmitting the programming that they provide.

Viewer channels represent the conduit through which viewers access programs. Specialized types of viewer channels also encompass the mechanism by which the programs are delivered to the viewers. Open-TV Compatible IRDs can describe only DSS Channels, but future receivers may permit use of other delivery mechanisms such as terrestrial broadcast. Everything needed to describe how to access a channel is encompassed within a DSS Channel. Note that a viewer channel has a time during which it is active. Outside of this time, the viewer channel will not be present in a guide.

Most viewer channels allow viewers to directly tune to them and provide a list of programs that are available on that channel. A public channel object is associated with each viewer channel with these characteristics. The public channel object provides descriptive information about the channel, such as a call sign, a description, and the event collection containing the programming that the channel provides. Public channels are generally independent of channel configuration.

Program Guide Objects

A viewer is a person that watches television. A viewer market is a set of viewers.

A receiver is the equipment that a viewer uses to acquire the data being broadcast. This data includes (but is not limited to) video and audio streams, applications, and schedule information. There are several different types of receivers (e.g., an OpenTV-compatible IRD or the tuner and antenna that come with a television). Different types of receivers have different capabilities. For our purposes, a receiver type is defined by its interface with the broadcast mechanism.

A guide is a set of data streams that a receiver may access to acquire information about channels, programming, and other configuration. Due to the variety of potential programming, languages, and receiver capabilities, distinct guides can be provided to different viewers. The major characteristics of a guide are what streams it has, how those streams are broadcast to a receiver, and what data fills each stream.

A guide environment describes for whom and what a guide is intended. It is defined by its viewer market and the receiver type that its viewers share. From this, the guide factory can determine what types of streams will compose the guide, what the format of the data will be that fills each stream, and what data is relevant to the targeted viewers. For instance, the viewer market may be used to determine the languages that should be used within the environment's guide.

Each guide stream is composed of one or more blocks of data called chunks. As time passes or new input is received by the guide factory, these chunks may be updated, replaced, or removed.

Examples of Program Guide Objects

The illustrative implementation supports one receiver type—the OpenTV-Compatible IRD. While there are IRDs that do not support and will never support OpenTV applications, all of the deployed receivers can decode a guide formatted according to the OpenTV-Compatible specification. There are two guide environments, typically referred to as East and West. Each receiver is assigned to exactly one of these guide environments (although this is not required by the guide environment concept). Each guide environment supports a guide with a Master Program Guide (MPG) stream, several Special Program Guide (SPG) streams, and several description streams. An MPG stream continually provides the IRD with the minimal information that it needs to function properly—channel allocations, current programming, and how to access the other guide streams. In the steady state, an MPG stream consists of a single repeated chunk. The MPG chunk may actually be slightly different each time it is broadcast since it includes the current time and the time remaining before a scheduled change to the chunk. Every half hour, this chunk is replaced with a new version that is constructed specifically for that half-hour time slot. In addition, whenever new data is received by the guide generator, the MPG chunk is replaced with a new version that reflects the new data. SPG streams and descriptions streams behave similarly.

Another receiver type might be defined so that receivers that conform to the Advanced Program Guide (APG) interface can be described. A new guide environment could then be created that encompasses all viewers with an APG Receiver. The guide for this environment would consist of several new types of streams—a boot stream, a frequency identification stream, a fast load stream, and update stream, and several carousel streams. Each of these streams would be populated by several small chunks. For instance, individual programs would have their own chunks. While a program is scheduled, its chunk will be part of one of the carousel streams. As the airtime of the program approaches, the program's chunk will be removed from one carousel stream and added to another. When a modification is made to the program (say a new title was provided), the program chunk is modified but remains part of the same carousel stream. If all instances of the program are unscheduled, its chunk will be removed from all streams.

The Illustrative system is provided with scheduling information (channel configurations and programming) from the program acquisitions database (PADB) 24. From this and some additional configuration information, the IPGS must construct the chunks necessary to populate each guide stream. For some guide environments, the necessary chunks can be determined from only the environment's configuration. For other environments, the scheduling information affects which chunks will be created. This will apply regardless of what channels and programs are available to the viewers. The number of SPG chunks to be created and which description streams are needed are affected by the channel configuration and amount of programming known at the time of generation. For an APG guide environment, however, separate chunks may be required for each known program or channel.

Chunks should be created as early as possible to ensure that they are available for transmission when they become active, even in the case of some network problems. A balance must be kept with the available scheduling information, however. An MPG chunk may be created for two weeks in the future, but it is unlikely to be useful. The scheduling information that is used to fill such a chunk will probably be modified between the MPG's construction and when the MPG becomes active. The probability of some change occurring to the input data must be weighed against the probability of a network failure between the guide factory and the driver for the time spanning the data update and the chunk's active period.

When the existence of a chunk is based upon the scheduling information, it makes sense to create the chunk as soon as the scheduling information is received by the IPGS. For example, a chunk for an APG channel object can be constructed as soon as the channel record for that channel configuration is received. This is true even if the channel configuration will not be active for some time yet, because the transmission of the chunk may be scheduled. When a modification is made to the channel configuration, a new version of the chunk can be constructed to replace the previous one. Notice that for this type of chunk, a chunk is only regenerated when a modification is made to an existing object in the scheduling information. New data creates new chunks without modifying existing ones.

The chunks for an OpenTV-Compatible Guide must be managed differently, however. An MPG chunk is closely related with a set of SPG chunks. Whenever one of these chunks is generated, they should all be generated. An MPG chunk and its associated SPG chunks are constructed specifically for a single half-hour time slot. Thus, a new version of each chunk is required every half hour. A new version can also be created whenever there is a change in the configuration of the guide environment or whenever new scheduling information is received. Because of the time dependence of these chunks, several different versions of an MPG chunk may be available at any time—each of them tailored to a different time slot. Newly generated MPG chunks may either add a new version for a new time slot or replace an existing version for a previously generated time slot.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for providing and modifying multiple unique program guides for one or more markets with respect to program content distributed in said markets via a telecommunications distribution network in accordance with a program schedule, said system comprising:
first means for providing a first program guide for a first market and a second program guide for a second market;
second means for inputting data with respect to updates for said first or said second program guide; and
third means for automatically updating or modifying said first program guide, said second program guide, parameters of said system, and/or a configuration of said system in response to said data.

2. The invention of claim 1 further including means for splitting said first and/or said second program guides.

3. The invention of claim 1 wherein said telecommunications network includes means for transmitting direct broadcast wireless signals encoded in accordance with a DSS transport protocol.

4. The invention of claim 1 wherein said first means includes a scheduling engine.

5. The invention of claim 4 wherein said scheduling engine includes a database.

6. The invention of claim 1 wherein said second means includes a user interface.

7. The invention of claim 6 wherein said second means includes a systems parameters user interface.

8. The invention of claim 6 wherein said second means includes a configuration user interface.

9. The invention of claim 6 wherein said second means includes an input data user interface.

10. The invention of claim 6 wherein said second means includes a monitor user interface.

11. The invention of claim 6 wherein said third means includes a configuration component coupled to said user interface.

12. The invention of claim 6 wherein said third means includes an input data component coupled to said user interface.

13. The invention of claim 6 wherein said third means includes a monitor component coupled to said user interface.

14. The invention of claim 6 wherein said third means includes a guide factory component.

15. The invention of claim 6 wherein said third means includes an uplink driver component.

16. The invention of claim 1 wherein said second means includes a web server.

17. A direct to home direct broadcast satellite network comprising:
a telecommunications network and
a system for providing and modifying multiple unique program guides for one or more markets with respect to program content distributed in said markets via said telecommunications network in accordance with a program schedule, said system comprising:
a scheduling engine;
a user interface coupled to said scheduling engine; and
a guide factory coupled to said scheduling engine.

18. The invention of claim 17 wherein said telecommunications network transmits and receives direct broadcast wireless signals encoded in accordance with a DSS transport protocol.

19. The invention of claim 17 further including means for splitting said first and/or said second program guides.

20. The invention of claim 17 wherein said scheduling engine includes a database.

21. The invention of claim 17 wherein said user interface includes a systems parameters user interface.

22. The invention of claim 17 wherein said user interface includes a configuration user interface.

23. The invention of claim 17 wherein said user interface includes an input data user interface.

24. The invention of claim 17 wherein said user interface includes a monitor user interface.

25. The invention of claim 17 wherein said guide factory includes a configuration component coupled to said user interface.

26. The invention of claim 25 wherein said guide factory includes an input data component coupled to said user interface.

27. The invention of claim 25 wherein said guide factory includes a monitor component coupled to said user interface.

28. The invention of claim 25 wherein said guide factory includes an uplink driver component.

29. The invention of claim 17 further including a web server.

30. A direct to home direct broadcast satellite network comprising:
a telecommunications network and
a system for providing and modifying multiple unique program guides for one or more markets with respect to program content distributed in said markets via said telecommunications network in accordance with a program schedule, said system comprising:
a scheduling engine for providing a first program guide for a first market and a second program guide for a second market;
a user interface for inputting data with respect to updates for said first or said second program guide; and
a guide factory for automatically updating or modifying said first program guide, said second program guide, parameters of said system, and/or a configuration of said system in response to said data.

31. A method for providing and modifying multiple unique program guides for one or more markets with respect to program content distributed in said markets via a telecommunications distribution network in accordance with a program schedule, said system including the steps of:
providing a first program guide for a first market and a second program guide for a second market;
inputting data with respect to updates for said first or said second program guide; and
automatically updating or modifying said first program guide, said second program guide, parameters of said system, and/or a configuration of said system in response to said data.
